(19) United States
(12) Patent Application Publication
(10) Pub. No.: US 2010/0138997 A1
(43) Pub. Date: Jun. 10, 2010

(54) PATIENT TRANSPORT UNIT AND METHOD FOR TRANSPORTING A PATIENT

(76) Inventors: Claus-Peter Höppner, Forchheim (DE); Tim Use, Nurnberg (DE)

Correspondence Address: BRINKS HOFER GILSON & LIONE, P.O. BOX 10395, CHICAGO, IL, 60610, US

(21) Appl. No.: 12/613,913

(22) Filed: Nov. 6, 2009

(30) Foreign Application Priority Data
Nov. 13, 2008 (DE) 10 2008 057 145.8

(51) Int. Cl. A61G 1/02; A61G 7/008; A61G 7/05

(52) U.S. Cl. 5/601; 5/86.1

(57) ABSTRACT

A transport unit with a support system for transporting a patient from a first room in at least one second room is provided. The transport unit includes a positioning device which interacts with the support system such that the transportation of the patient from the first into the second room is able to be undertaken in a tilted and/or rolled position. Accordingly, internal organs of the patient remain in their previously assumed position during transportation of a patient.

This application claims the benefit of DE 10 2008 057 145.8 filed Nov. 13, 2008, which is hereby incorporated by reference.

### BACKGROUND

The present embodiments relate to transporting a patient.

The application of ionizing radiation in medicine is referred to as radiation therapy. Within the medical field, high-energy radiation (e.g., x-ray radiation, gamma radiation) or particle radiation (e.g., electrons, protons, carbon ions, etc.) is directed to the body of a patient to be treated. However, an application of radiation can also be used in non-therapeutic areas, such as in the irradiation of phantoms or non-living bodies within the framework of research work or in the irradiation of materials.

For particle therapy high-energy particle radiation is generated with an accelerator installation. The particles accelerated to high energies are formed into a particle beam and subsequently directed onto the tissue to be irradiated. The particles penetrate into the tissue to be irradiated and emit their energy there in a prescribed area. The penetration depth in the tissue to be irradiated primarily depends on the energy of the particle beam. The higher the energy of the particle beam, the deeper the particles penetrate into the tissue to be irradiated. By comparison with conventional irradiation methods which operate with x-rays, particle therapy is characterized by the energy of the particles being emitted in a prescribed and delimitable area. This enables a tumor for example to be irradiated more precisely and surrounding tissue can be better protected.

Particle therapy is usually undertaken in a special particle therapy system in which the particle beam is generated in one area and directed to a number of radiation rooms. The radiation rooms may be available in a different area in which patients are prepared for subsequent radiation treatment or are irradiated during an irradiation session.

FIG. 1 shows a schematic overview of a structure of a particle therapy system 10 in accordance with the subsequently published DE 10 2008 005 068 A1. Ions such as protons, helium ions or carbon ions are primarily used as particles. The particles are generated in a particle source 11. If, as shown in FIG. 1, two particle sources 11 are available which generate two different types of ion, a switchover can be made within a very short time between these two types of ion. A switching magnet 12 is typically used for this purpose, which is arranged between the ion sources 11 and a pre-accelerator 13. This allows the particle therapy system 10 to be operated with protons and with carbon ions at the same time.

The ions generated by the ion source or by one of the ion sources 11, and if necessary selected by the switching magnet 12, are accelerated in the pre-accelerator 13 up to a first energy level. The pre-accelerator 13 may be a linear accelerator. Subsequently the particles are fed into an accelerator 15, for example, a synchrotron. In the accelerator 15 they are accelerated to high energies as are required for irradiation. After the particles have left the accelerator 15, a high-energy beam transport system 17 conducts the particle beam to one or more irradiation rooms 19. In an irradiation room 19 the accelerated particles are directed onto a part of the body to be irradiated. Depending on the design this is done from a fixed direction or from different directions via a gantry 21 that permits rotational movement around an axis 22.

The particle therapy system 10 features additional (further) rooms 23 in which example patients are prepared for a subsequent irradiation session or for a subsequent examination. These additional rooms 23 and the irradiation rooms 19 are connected to each other via corridors 25. A patient may be prepared in one room and is subsequently taken into another room. Preparation generally includes positioning of the patient on a transport unit 27 so that the patient positioned on the transport unit 27 can then be moved into another room. The transport unit 27 in such cases is both a patient support system and also patient transport system, since a patient is both supported on the transport unit and also transported by a transport unit from room to room.

If patients are prepared for an irradiation session, they are usually positioned on a patient holder system and may be fixed so that later in a radiation room a precise orientation of the patient can be undertaken in relation to the particle beam. Patient transport units are used to arrange the treatment of the patient to be as effective as possible. These types of transport units are patient support and patient transport facilities on which a patient is supported and can, if necessary, be fixed and with which a patient is subsequently able to be moved from one room into another room, for example, from a preparation room into an irradiation room.

In the preparation room, the patient position and especially the position of the area of the patient's body to be irradiated can if necessary be verified by medical imaging. X-ray tomographic imaging, such as computed tomography, may be used to verify the position. Planning is undertaken with a dataset from computed tomography. In such cases, the patient is positioned on a table, the table plate of which is aligned as horizontally as possible.

During planning, it may be determined that treatment in a tilted and/or rolled (i.e., canted or angled or slanted) position would be a good idea. By changing the body position, such as tilting or rolling, the positions of the internal organs also change and a discrepancy thus arises between the original planning and the current position of the patient. This problem can be resolved using a robot in planning computed tomography and with a robot in treatment, with the robots rotating the surfaces on which the patient is lying accordingly.

Before an irradiation treatment, the patient will be prepared in a preparation room for the treatment. To this end the patient is laid on a horizontal table. To increase the accuracy of the treatment, an x-ray image may be taken. Depending on the installation equipment the x-ray image may be taken in the treatment room or outside in a separate CT room. In a second case, the patient must first be taken into the treatment room after the position verification before the treatment can take place.

After a position verification outside the treatment room in a tilted/rolled position determined from the planning, the transport of the patient in a horizontal position from the imaging/preparation room into the treatment room produces displacements of the organs and of the tumor and thereby errors in the irradiation.

### SUMMARY AND DESCRIPTION

The present embodiments may obviate one or more of the drawbacks or limitations in the related art. For example, in one embodiment, a transport unit and a method for transporting patients in which no displacement of the organs results from patient transport may be provided.

In one embodiment, a transport unit (e.g., system) is provided. The transport unit includes a support system (e.g., facility or device) for transporting (e.g., conveying or moving) a patient from a first room into at least one second room. The transport unit includes at least one means which interoperates with the support system in order to undertake the transportation of the patient from the first room into the second room in a tilted and/or rolled position.

Position verification may be undertaken outside a treatment room. Accordingly, a computer tomography device may be used with an improved resolution compared to a standard robot imager system, as is currently planned in treatment rooms. Smaller treatment rooms, as compared to planning in which a computer tomograph is to be accommodated in a treatment room, may be used. The usage time of treatment rooms may be improved since the process of position verification takes place in another room and the treatment room can be used in the interim for another treatment.

The early positioning of the patient in the planning and treatment position enables the planning and the treatment to be undertaken with high precision.

In one embodiment, the transport unit may include a transportation (e.g., conveyance) device to accommodate and transport (e.g., convey or move) the support system. Accordingly, the support system may be separated from the transportation system.

The positioning device may be a part of the transportation system. This offers the advantage of height adjustments also being able to be undertaken without the support system.

The transport unit may include at least an immobilization device which interoperates with the support system such that the patient can be immobilized on the support system. Accordingly, the patient and their organs retain the position assumed and set even during transportation.

The positioning device may include two vertically-movable first carriers and two second carriers, with the second carriers each being rotatably supported on a first carrier. The support system may be detachably arranged on the second carriers and the tilting may be undertaken by a different height adjustment of the first carriers and the rolling being undertaken by rotating the second carriers. The advantage of this is a robust and simple adjustment process.

In one embodiment, the support system may include half-shell elements on the underside in at least three corners in which corresponding ball heads of height-adjustable third carriers engage such that as a result of different heights of the ball heads the support system can be tilted and/or rolled. This enables the support system to be adjusted in a simple and safe manner.

The transport unit may include the first holder module. A robot arm may use the first holder module to receive the support system. This offers the advantage of the support system being able to be transferred safely and precisely by a robot system.

The transport unit may include a second holder module. A support system may be fixed detachably to the transportation system using the second holder module. The fixing may be detached automatically on transfer of the support system by a robot arm. The support system is connected by this securely to the transportation system during movement and may be automatically transferred by a robot system.

The transport unit may include a display unit which outputs current values of rolling and tilting, required values of rolling and tilting and/or deviations between the actual values and the required values. This enables an operator to detect the status of the orientation of the support system at any time.

In one embodiment, the transport unit may include an electromechanical drive and associated controls which affect the tilting and/or rolling. This offers a secure operation which saves operators effort.

In one embodiment, the transport unit may include a rechargeable battery arranged in the transportation unit for supplying power to the electromechanical drive. The advantage of this is independence from a stationary power supply.

The present embodiments may also include the use of a transport unit for conveying immobilized patients between rooms of a radiation therapy installation. This offers the advantage of the exact radiation treatment in a tilted and rolled position of the patient.

Furthermore, the present embodiments may also include a method for conveying a patient from a first room into at least one second room. The method may include immobilizing the patient on a support system, tilting and/or rolling the support system into a predeterminable position, and transporting (e.g., conveying or moving) the support system in the predeterminable position from the first room into the second room.

The first room may be a preparation room and the second room an irradiation room of the radiation therapy installation. Accordingly, after preparation of a patient, their organs remain in an unchanged position during transportation.

In one embodiment, the transportation of the support system can be undertaken on a mobile transportation system, with the tilting and rolling of the support system being undertaken by the transportation system.

Furthermore, the method may include transferring the support system from the transportation system by a robot positioning system.

### BRIEF DESCRIPTION OF THE DRAWINGS

FIG. 1 illustrates an overview of a particle therapy system,

FIG. 2 illustrates one embodiment of a transport unit with movable carriers,

FIG. 3 illustrates one embodiment of a transport unit with ball heads, and

FIG. 4 illustrates one embodiment of a transportation method.

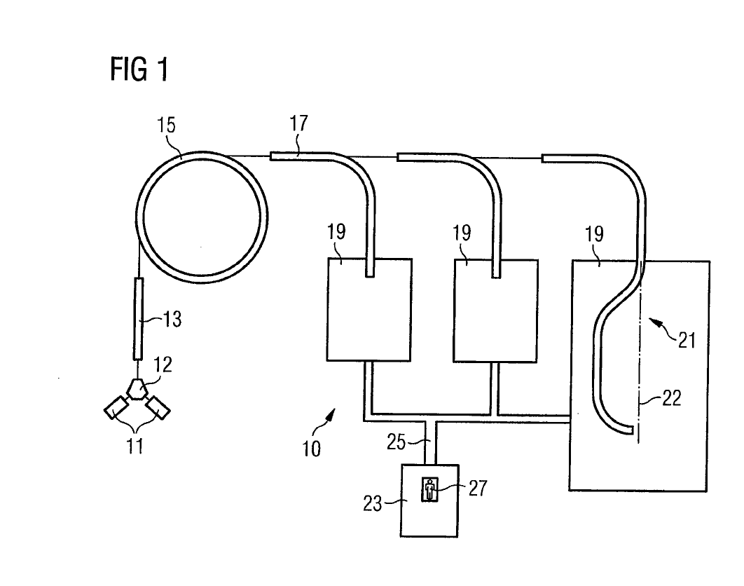

### DETAILED DESCRIPTION

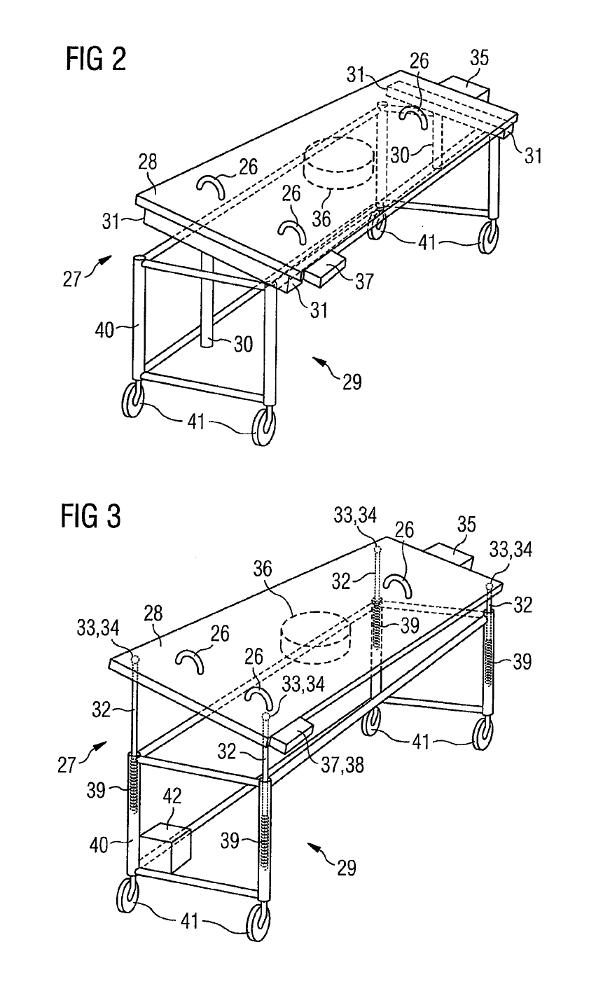

FIG. 2 shows a perspective view of a transport unit 27 for transporting patients from a room of a radiation treatment system into another room of the radiation treatment system. The radiation treatment system may be a particle therapy system. The transport unit 27 may be a patient shuttle.

The transport unit 27 comprises a transportation system 29 on which a support system 28 is arranged. Both facilities are connected to each other with a second holder module 36 so that they are detachably movable in relation to each other. The transportation system 29 comprises a frame 40 and four wheels 41 arranged below the frame 40 for moving the transport unit 27. The wheels 41 may be rail wheels for rolling on a rail system.

To change the spatial orientation of the support system 28 in parallel to a floor surface, two first carriers 30 are each attached to one end of the frame 40 with height adjustment. On the two carriers 30 second carriers 31 are rotatably supported in an initial position horizontal to the surface of the floor. On the two second carriers 31 lies the support system 28. By an unequal height adjustment of the two first carriers 30 the support system 28 is tilted. In other words, the support system 28 is rotated around a transverse axis. A rotational movement of the second carrier 31 allows the support system 28 to be rolled. In other words, the support system 28 is rotated around a longitudinal axis. The tilting is also referred to as “roll”; the rolling is also referred to as “tilt” or “pitch”.

With the aid of an immobilization device 26 a patient can be immobilized on the support system. Immobilized includes fixed in a preferred position for a treatment. Thus the patient can be transported in the tilted and rolled position from, for example, a preparation room of the particle therapy system into a treatment room or an irradiation room of the particle therapy system. On a display unit 37 mounted on the transportation device 29 the different angles of inclination of the tilting and rolling can be output. The height adjustment of the first carrier 30 and the inclination of the second carrier 31 can be undertaken manually by mechanical levers not shown in the diagram. A first holder (e.g., retaining) module 35 connected to the support system 28 serves as a gripping point for a robot arm to enable it to lift the support system 28 away from the transportation system 29.

FIG. 3 shows the perspective view of a further transport unit 27 for transporting patients from a room of a radiation treatment system into a further room of the radiation treatment system. The transport unit 27 includes a transportation system 29 on which the support system 28 is arranged. The transportation system 29 and support system 28 are connected movably detachably to each other with the aid of a second holder module 36. The transportation system includes a frame unit 40 and four wheels 41 arranged below the frame unit 40 for moving the transport unit 27.

To change the spatial orientation of the support system 28 in parallel to a floor surface, half-shell-shaped openings 33 are made in the four corners of the underside of the support system 28 into which corresponding ball heads 34 of height-adjustable third carriers engage precisely. The four third carriers 32 are connected via an electromechanical drive 39 to the frame unit 40. The electromechanical drive is supplied with electrical energy by a rechargeable battery 42 of the transportation system 29. The heights of the ball heads 34 can be controlled by a control element. The support system 28 can be tilted and/or rolled in relation to a floor surface by different heights of the ball heads 34. The immobilization device 26 may be used such that a patient can be immobilized on the support system 28. A first retaining module 35 serves as a gripping point for a robot arm to lift the storage system 28 away from the transportation system 29.

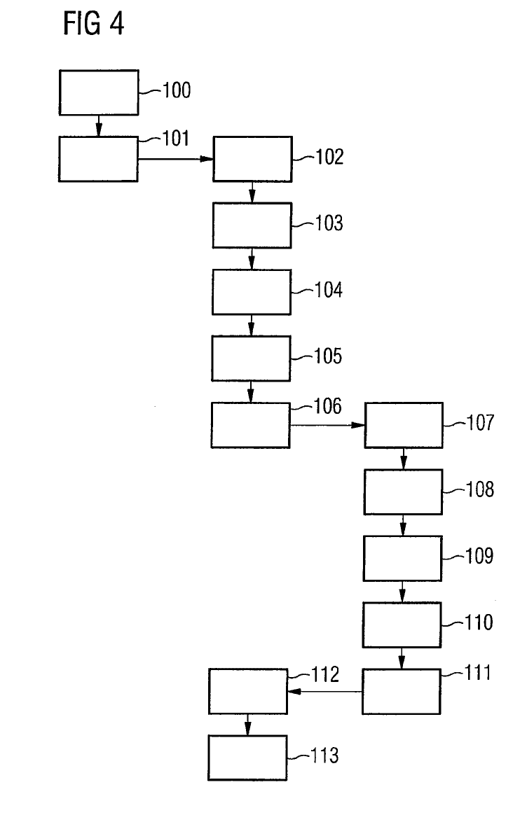

FIG. 4 shows the flow diagram of an inventive method for conveying a patient from a preparation room into a treatment room. The method may include acts 100-113.

In act 100, a treatment region may be planned, for example, with a patient support system being able to assume tilt and/or roll positions. In act 101, the patient may be immobilized on a transport unit. In act 102, the patient may be transported on the transport unit into the preparation room for position verification, for example, with a computed tomography system with robot system for positioning the patient support system. The patient position may be set with a robot also in tilt and/or roll angles, as shown in act 103. Position verification in the treatment position may be performed in act 104. As shown in act 105, the roll and/or tilt angle may be set at a transportation system of the transport unit. The patient support system may be transported from the robot to the transportation unit in act 106. During transportation, the tilt and/or roll position of the support system may be retained. The patient may be transport with the transport unit into the treatment room, as shown in act 107. In act 108, transfer of the patient on the support system by a robot positioning system in the treatment room may be performed. In act 109, the patient may be positioned in the treatment position in front of a particle beam output. In act 110, the patient may be treated. In act 111, the patient may be laid with the support system on the transportation unit in a substantially horizontal position or laying the patient in the tilted and rolled position and moving the support system into a horizontal position. In act 112, the patient may be transported out of the treatment room. In act 113, the patient may be mobilized.

There may be, for example, several days between step 100 and 101. The patient positioning and imaging can also take place in the same room.

The system described above and the method can accordingly also be used in an irradiation device with ionizing radiation.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A transport unit comprising:
a support system for transporting a patient from a first room into at least one second room, and
a positioning device that interacts with the support system such that transportation of the patient from the first room into the second room is able to be undertaken in a tilted and/or rolled position.

2. The transport unit as claimed in claim 1, further comprising a transportation system which is embodied for receiving and conveying the support system.

3. The transport unit as claimed in claim 2, wherein the positioning device is a part of the transportation system.

4. The transport unit as claimed in claim 1, further comprising an immobilization device which interacts with the support system such that the patient is immobilized on the support system.

5. The transport unit as claimed in claim 1, wherein the positioning device comprises two vertically movable first carriers and two second carriers, the second carriers each being rotatably supported on a first carrier, the support system being arranged detachably on the second carriers and with the system being tilted by different height adjustment of the first carriers and being rolled by rotating the second carriers.

6. The transport unit as claimed in claim 1, wherein the support system includes half-shell elements on an underside in at least three corners, into which corresponding ball heads of height-adjustable third carriers engage such that the support system is able to be tilted and/or rolled by different heights of the ball heads.

7. The transport unit as claimed in claim 1, further comprising a first holder module with which a robot arm can accept the support system.

8. The transport unit as claimed in claim 2, further comprising a second holder module, with which the support system is able to be firmly fixed detachably to the transportation system, with the fixing able to be released automatically on transfer of the support system by a robot arm.

9. The transport unit as claimed in claim 1, further comprising a display unit that is operative to output current values of the tilting and rolling, required values of the tilting and/or rolling and/or deviations of the current values from the required values.

10. The transport unit as claimed in claim 1, further comprising an electromechanical drive and a control unit operative to control tilting and/or rolling.

11. The transport unit as claimed in claim 10, further comprising at least one rechargeable cell arranged in a transportation unit and operative to supply energy to the electromechanical drive.

12. A method for using a transport unit to transport immobilized patients between rooms of a radiation therapy system, the method comprising:
using a support system for transporting a patient from a first room into at least one second room, and
using a positioning device that interacts with the support system such that transportation of the patient from the first room into the second room is able to be undertaken in a tilted and/or rolled position.

13. A method for transporting a patient from a first room into at least one second room, the method comprising:
immobilizing the patient on a support system,
tilting and rolling of the support system into a predeterminable position, and
transporting the support system in the predeterminable position from a first room into a second room.

14. The method as claimed in claim 13, wherein the first room is a preparation room and the second room is a radiation room of a radiation therapy system.

15. The method as claimed in claim 13, wherein transporting the support system includes transporting on a movable transportation system, with the tilting and rolling of the support system by the transportation system.

16. The method as claimed in claim 13, further comprising transferring of the support system from the transportation system by the robot positioning system.
